(19) United States
(12) Patent Application Publication
(10) Pub. No.: US 2008/0278598 A1
(43) Pub. Date: Nov. 13, 2008

(54) Devices, Systems, and Methods Regarding Camera Imaging

(76) Inventors: Michael Philip Greenberg, Goffstown, NH (US); Thomas G. Murphy, Manchester, NH (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/117,011

(22) Filed: May 8, 2008

Related U.S. Application Data
(60) Provisional application No. 60/917,393, filed on May 11, 2007.

(51) Int. Cl. H04N 5/228

(52) U.S. Cl. 348/222.1; 348/E05.031

(57) ABSTRACT

Certain exemplary embodiments can provide a method that can comprise automatically rendering an image. The image can be transferred to a memory from a digital camera via a Field Programmable Gate Array (FPGA) device. The FPGA device can be adapted to transfer image information from the digital camera to a memory.

### CROSS-REFERENCES TO RELATED APPLICATIONS

This application claims priority to, and incorporates by reference herein in its entirety, pending U.S. Provisional Patent Application Ser. No. 60/917,393 (Attorney Docket No. 2007P09970US), filed May 11, 2007.

### BACKGROUND

Certain reduced instruction set computer (RISC) central processing unit (CPU) architectures can execute relatively complex algorithms from high level source code. However, such RISC CPU architectures might not be as efficient as a digital signal processor (DSP) device when executing algorithms that perform simple operations on numerical arrays such as are sometimes found in image pre-processing operations.

### SUMMARY

Certain exemplary embodiments can provide a method that can comprise automatically rendering an image. The image can be transferred to a memory from a digital camera via a Field Programmable Gate Array (FPGA) device. The FPGA device can be adapted to transfer image information from the digital camera to a memory.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a block diagram of an exemplary embodiment of a field programmable gate array 2000;

FIG. 3 is a block diagram of an exemplary embodiment of a digital signal processor 3000;

FIG. 4 is a flowchart of an exemplary embodiment of a method 4000; and

FIG. 5 is a block diagram of an exemplary embodiment of an information device 5000.

### DETAILED DESCRIPTION

Certain exemplary embodiments can provide a method that can comprise automatically rendering an image. The image can be transferred to a memory from a digital camera via a Field Programmable Gate Array (FPGA) device. The FPGA device can be adapted to transfer image information from the digital camera to a memory.

Certain exemplary embodiments can utilize an FPGA device to act as an interface between an imaging device, such as a camera, and an information device. The FPGA device can be adapted to acquire image information from the camera for transfer to the information device via an image acquisition direct memory access (DMA) channel. The FPGA device can be adapted to control one or more functions of the imaging device such as controlling lighting, controlling a zoom lens, and/or controlling an image resolution, etc. In certain exemplary embodiments the FPGA device can be adapted to perform one or more processing algorithms on image information obtained from the imaging device

In certain exemplary embodiments, image information can be transferred from the information device to the FPGA device via an image processing DMA channel, thus utilizing main processor memory to provide input and/or receive output from the array processing circuitry. The image processing DMA channel can be distinct from the image acquisition DMA channel.

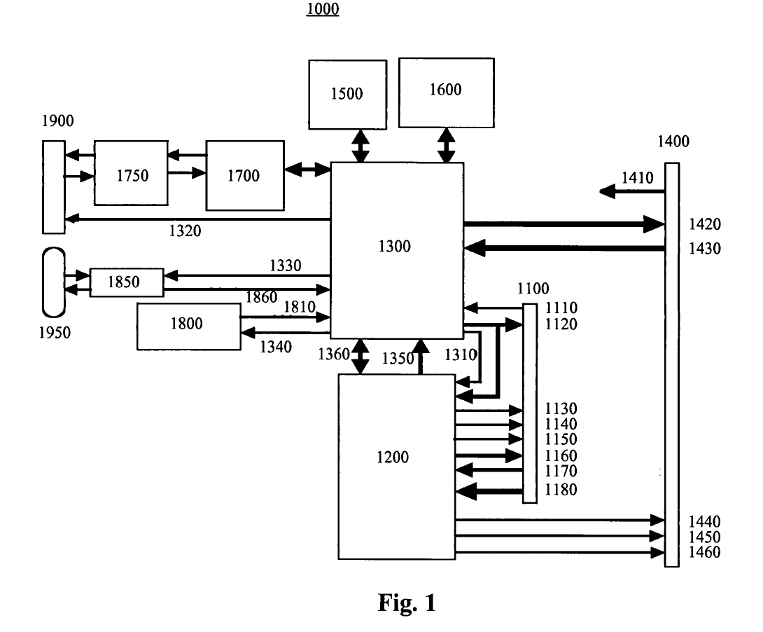

FIG. 1 is a block diagram of an exemplary embodiment of a system 1000, which can comprise an imaging device 1100, an FPGA 1200, a processor 1300, a Power Supply/Input-Output module (PSIO) 1400, a flash memory 1500, a main memory 1600 (e.g., a synchronous dynamic random access memory), a network interface 1900, and a device interface 1950. In certain exemplary embodiments, imaging device 1100 can be a digital camera and/or a machine vision device.

PSIO 1400 can be adapted to determine and/or control illumination associated with imaging device 1100, such as via control of a strobe illuminator. Channels associated with PSIO 1400 that carry signals associated with PSIO 1400 can be a power in channel 1410, general purpose output channel 1420 from processor 1300, general purpose input channel 1430 to processor 1300, target enable channel 1440 from FPGA 1200, strobe channel 1450 from FPGA 1200, and/or strobe power channel 1460 from FPGA 1200.

Imaging device 1100 can be adapted to communicate with FPGA 1200 and/or processor 1300 via a set of channels that can comprise a data input (TDI) channel 1110, Joint Test Action Group (JTAG) out channel 1120, data output (TDO) channel 1130, expose channel 1140, first analog to digital conversion channel 1150, second analog to digital conversion channel 1160, line enable/frame enable/clock channel 1170, and/or video channel 1180.

FPGA 1200 can be adapted to be an interface between imaging device 1100 and processor 1300. FPGA 1200 can utilize a first DMA channel 1350 to transfer image information from imaging device 1100 to main memory 1600 via processor 1300. FPGA 1200 can be adapted to process a set of image pixels received from main memory 1600 via second DMA channel 1360. FPGA 1200 can be adapted to process the set of image pixels and to return the processed set of image pixels data main memory 1600 via second DMA channel 1360. In certain exemplary embodiments, the set of image pixels can correspond to a rectangular region of the image information. In certain exemplary embodiments, processor 1300 can be adapted to communicate with FPGA 1200 via a data output channel 1310.

Processor 1300 can be communicatively coupled to a network interface 1900 via a physical module 1700 and a transformer module 1750. In certain exemplary embodiments, network interface 1900 can be an RJ 45 interface. Processor 1300 can communicate with network interface 1900 via a network status channel 1320, which can be adapted to transmit a signal that causes one or more light emitting diodes associated with network interface 1900 to be illuminated. Processor 1300 can be communicatively coupled to a supervisor device 1800. Communications between processor 1300 and supervisor device 1800 can be via a reset channel 1810 and a watchdog channel 1340. Processor 1300 can be communicatively coupled to a device interface 1950 via a transceiver module 1850. Processor 1300 can communicate with transceiver module 1850 via serial out channel 1330 and a serial in channel 1860. In certain exemplary embodiments, device interface 1950 can be a Deutsches Institut für Normung (DIN) 8 interface.

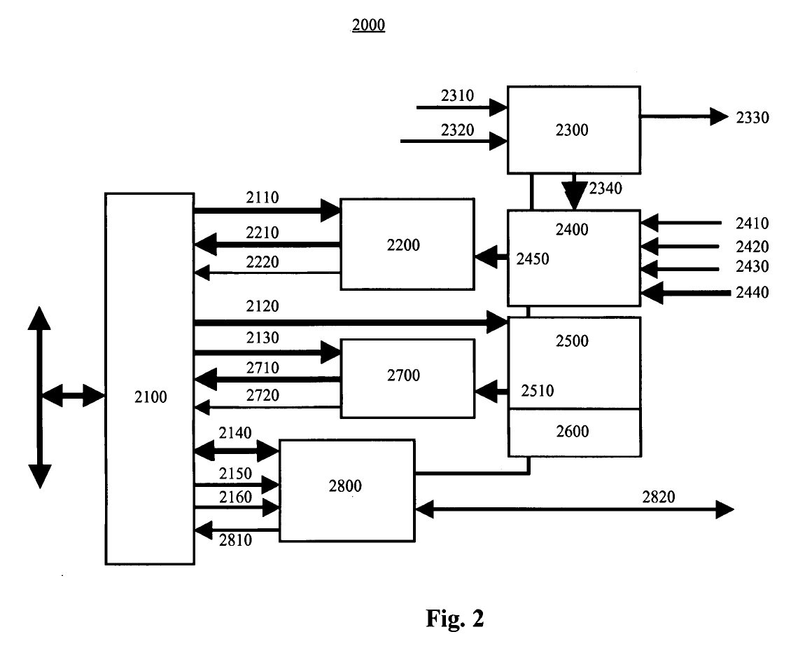

FIG. 2 is a block diagram of an exemplary embodiment of a field programmable gate array 2000, which can be an FPGA that is usable as FPGA 1200 if FIG. 1. FPGA 2000 can comprise a PCI target circuit 2100, a video buffer, 2200, an expose sequencer 2300, a pixel assembler 2400, a DSP block 2500, a set of results registers 2600, a results buffer 2700, and a set of control status registers 2800. PCI target circuit 2100 can communicate with video buffer 2200 via an address channel 2110, a data channel 2210, and an output ready channel 2220. Video buffer 2200 can communicate with pixel assembler 2400 via a pixel channel 2450. Pixel assembler 2400 can be adapted to receive signals via a clock channel 2410, a frame enable channel 2420, a line enable channel 2430, and a video channel 2440. Expose sequencer 2300 can communicate with pixel assembler 2400 via a capture channel 2340. Expose sequencer 2300 can be communicatively coupled with one or more electronic devices via a clock channel 2310, an external trigger channel 2320, and a lighting control channel 2330.

PCI target circuit 2100 can communicate with DSP block 2500 via a data in channel 2120. DSP block 2500 can process image information received via data in channel 2120 and provide an output signal to results buffer 2700 via a results channel 2510. Results buffer 2700 can communicate with PCI target circuit 2100 via address channel 2130, data out channel 2710, and output ready channel 2720. Processed image information from DSP block 2500 can be provided to PCI target circuit 2100 via data out channel 2710. Set of control status registers 2800 can communicate with PCI target circuit 2100 via a data channel 2140, a read channel 2150, a write channel 2160, and a ready channel 2810. Set of control status registers 2800 can communicate with an external device and/or system via a miscellaneous input/output (I/O) channel 2820.

FPGA 2000 can have a relatively low power consumption and cost. However, since a processor of an information device can comprise multiple DMA channels, a secondary PCI target address space can be defined, which comprises addressable addresses of DSP Block 2500. A first DMA channel can be dedicated to image capture. A second DMA channel can be programmed such that image pixels from a desired rectangular region of interest (ROI) are written to DSP block 2500, where the pixels can be processed. Some DSP operations generate approximately ROI-sized output arrays (processed images). In such cases, processed image information can be placed in results buffer 2700 and can be transferred via the second DMA channel to a memory that can be communicatively coupled to the processor. In certain exemplary embodiments, results can be read out of results buffer 2700 under program control for immediate processing by the processor. DSP operations, whether or not used to generate result images, can be adapted to generate summarized result values. In certain exemplary embodiments, summarized result values can be placed in results registers 2600 and/or directly read out by PCI target register read operations.

The second DMA channel, which can be dedicated to DSP operations, can alternate moving data from processor memory to the FPGA DSP block with moving result data from the results buffer 2700 to processor memory. In certain exemplary embodiments, a Sobel Filter operation inputs an N×M ROI and outputs two (N-2)×(M-2) GradX and GradY result arrays. The DMA descriptor chain can write three ROI rows of N pixels to the DSP block before reading two GradX and GradY rows of N-2 pixels each. After writing the last ROI input row, the last two result rows can be read out.

In certain exemplary embodiments, DSP block 2500 can be adapted to perform one or more of the following candidate operations:
a pixel tool operation that accepts an input of a grayscale ROI and outputs one of the following images:
   “city block Sobel” (|GradX|+|GradY|) or separate (signed) GradX and GradY;
   binarized grayscale (inclusive or exclusive of two thresholds); and/or
   binarized Sobel; etc.
and/or statistics, such as:
   a sum of Sobel values for all pixels having a gray value that are greater and/or less than threshold values; and/or
   a count of Sobel values for all pixels having a gray value that are greater and/or less than threshold values; etc.;
binarized images can be written as byte values of 0×00 or 0×01, which can be an input format used by a binary morphology operation;
a binary morphology operation that accepts an input of a binarized image; and can accept a specified border value, an ROI height, and an ROI width and can output a binarized image of equal size and/or a count of pixels modified;
a 3-value morphology operation that “colors” pixels in order to perform break detection, which can be similar to the binary morphology operation, but can use a bit 1 to indicate “color”, use a color descriptor, generate a count of pixels modified, and/or generate a count of pixels colored; etc.;
a gray morphology operation that accepts a grayscale image input and can output one of the following images:
   a central pixel replaced by a minimum neighborhood value;
   a central pixel replaced by a maximum neighborhood value; and/or
   border pixels of 0xFF for a minimum and 0x00 for a maximum operation; and/or
a histogram operation that accepts as an input a grayscale or Sobel image and can collect counts of each pixel value in the ROI in a set of result registers (e.g., 256 registers); etc.

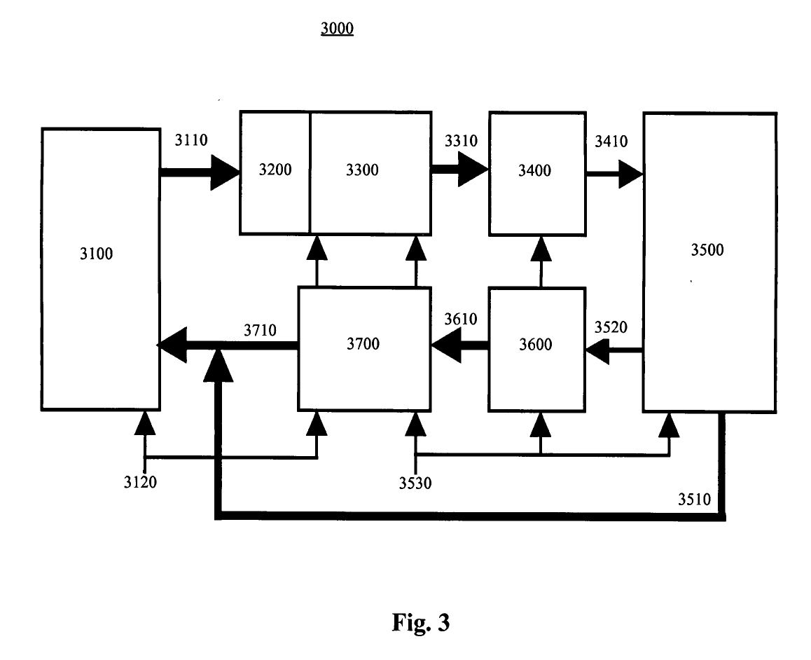

FIG. 3 is a block diagram of an exemplary embodiment of a digital signal processor 3000, which can comprise a PCI target circuit 3100, an input alignment circuit 3200, an input first-in-first-out buffer 3300, an input unpack circuit 3400, a DSP array 3500, an output pack circuit 3600, and a results buffer 3700. Results buffer 3700 can be a first-in-first-out buffer. Image information can be transferred from PCI target circuit 3100 to DSP array 3500 via a write channel 3110, a raw data channel 3310, and a DSP input channel 3410. Processed image information can be transferred from DSP array 3500 to PCI target circuit 3100 via a DSP output channel 3520, a processed data channel 3610, and a read data channel 3710. DSP array 3500, output pack circuit 3600, and results buffer 3700 can receive time information from a DSP clock input 3530. PCI target circuit 3100 and results buffer 3700 can receive time information from a PCI clock input 3120.

PCI Target circuit 3100 can deliver longword DMA write data to input align circuit 3200, which can extract bytes (e.g., pixels) starting on one of four possible pixel boundaries according to PCI byte enable lines, repack the pixels into longwords, and push the pixels onto input first-in-first-out buffer 3300. Input unpack circuit 3400 can supply pixels one at a time to DSP array 3500. DSP array 3500 can output processed pixels to output pack circuit 3600, which can push four pixels at a time onto results buffer 3700. When a pixel count expires, output pack circuit 3600 can pad a final longword for an image. Results buffer 3700 can supply DMA read data to PCI Target circuit 3100. Results register data can be provided to PCI Target circuit 3100 via PCI target read data channel 3510.

In certain exemplary embodiments, two first-in-first-out buffers can allow a DSP clock of digital signal processor 3000 to operate asynchronously at as high a speed as is practical for a given FPGA device. Width and height counters in DSP array 3500 can determine a start and end of each row, including a first and last row of an image. Signals from width and height counters can allow a generation of border values for morphology and padding rows and columns for other neighborhood operations so that input and output ROIs can be made identical in size.

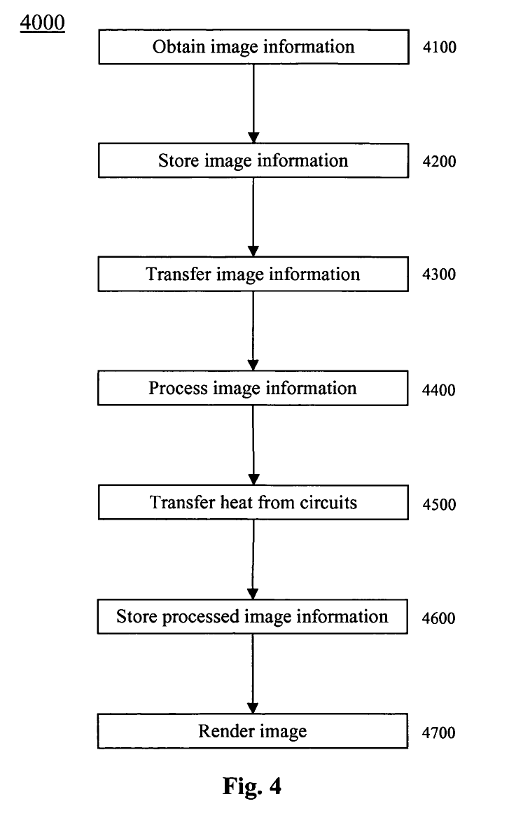

FIG. 4 is a flowchart of an exemplary embodiment of a method 4000. Activities of method 4000 can be performed automatically. In certain exemplary embodiments, machine instructions adapted to perform any activity, or any subset of activities, of method 4000 can be stored on a machine-readable medium. At activity 4100, image information, which can comprise an image, can be obtained at an imaging device, such as a digital camera. The image information can be transferred to a memory from the imaging device via an FPGA device. The FPGA device can be adapted to transfer image information from the digital camera to a main memory of a processor via a pixel buffer of the FPGA device and/or a first DMA channel.

At activity 4200, the image information can be stored in the main memory of the processor. The main memory of the processor can be adapted to receive the image information and/or transfer the image information via the processor without interrupting execution of an operating program under execution by the processor.

At activity 4300, a set of image pixels can be transferred from the memory device to the FPGA device for processing. The FPGA device can be adapted to receive the set of image pixels from the processor via a second DMA channel. The set of image pixels can correspond to a rectangular region of the image information.

At activity 4400, the image information can be processed. The FPGA device can be adapted to process the set of image pixels. In certain exemplary embodiments, the FPGA device can be adapted to perform a binary morphology on the set of image pixels at the FPGA device. Certain exemplary embodiments can perform a Sobel Filter operation on the set of image pixels at the FPGA device.

In certain exemplary embodiments, the set of image pixels can be a portion of a grayscale image determined from the image and the FPGA device can be adapted to process the portion of the grayscale image and output a City block Sobel image. In certain exemplary embodiments, the set of image pixels can be a portion of a grayscale image determined from the image and the FPGA device can be adapted to process the portion of the grayscale image and output a binarized grayscale image. In certain exemplary embodiments, the set of image pixels can be a portion of a grayscale image determined from the image and the FPGA device can be adapted to process the portion of the grayscale image and output a binarized Sobel image.

In certain exemplary embodiments, the set of image pixels can be a portion of a grayscale image determined from the image and the FPGA device can be adapted to process the portion of the grayscale image and output a sum of Sobel values for pixels of the set of image pixels with a grayscale value that exceeds a predetermined threshold. In certain exemplary embodiments, the set of image pixels can be a portion of a grayscale image determined from the image and the FPGA device can be adapted to process the portion of the grayscale image and output a count of Sobel values for pixels of the set of image pixels with a grayscale value that exceeds a predetermined threshold. In certain exemplary embodiments, the set of image pixels can be a binarized image and the FPGA device can be adapted to modify the binarized image based upon a specified border value and a height of the rectangular region of the image.

In certain exemplary embodiments, the set of image pixels can be a binarized image and the FPGA device can be adapted to perform break detection via colored pixels of the binarized image. In certain exemplary embodiments, the set of image pixels can be a grayscale image and the FPGA device can be adapted to process the grayscale image and output image data that comprises a central pixel replaced by a minimum neighborhood value. In certain exemplary embodiments, the set of image pixels can be a grayscale image and the FPGA device can be adapted to process the grayscale image and output image data that comprises a central pixel replaced by a maximum neighborhood value.

The FPGA device can be adapted to transfer the set of image pixels to the processor via a results buffer and/or the second DMA channel. In certain exemplary embodiments, the set of image pixels can be read from the results buffer of the FPGA device via a Peripheral Connect Interface (PCI) target register read operation.

At activity 4500, heat can be transferred from circuits of the FPGA device. A surface of the FPGA device can transfer heat via conduction, convection, and/or radiation to a heat sink. In certain exemplary embodiments, a cooling fan can be used to enhance heat transfer from the processor and/or the FPGA device. In certain exemplary embodiments, heat can be transferred from a first circuit in a Field Programmable Gate Array (FPGA) device. The first circuit of the FPGA device can be controlled by a direct memory access controller. The first circuit can be adapted to transfer image information from the digital camera to the processor of an information device via a first direct memory access (DMA) channel. The FPGA device can be adapted to transfer heat from a second circuit. The second circuit can be adapted to receive a set of image pixels from the processor via a second DMA channel, which can be separate and distinct from the first DMA channel. the set of image pixels can correspond to a rectangular region of the image information. The FPGA device can be adapted to process the set of image pixels. The FPGA device can be adapted to transfer the set of image pixels to the processor via the second DMA channel.

At activity 4600, the processed image information can be received and/or stored in the main memory of the processor. The processor can be adapted to further process the image information and/or transfer the image information to another device and/or system to further process the image information.

At activity 4700, an image can be rendered at a user interface based upon the processed image information.

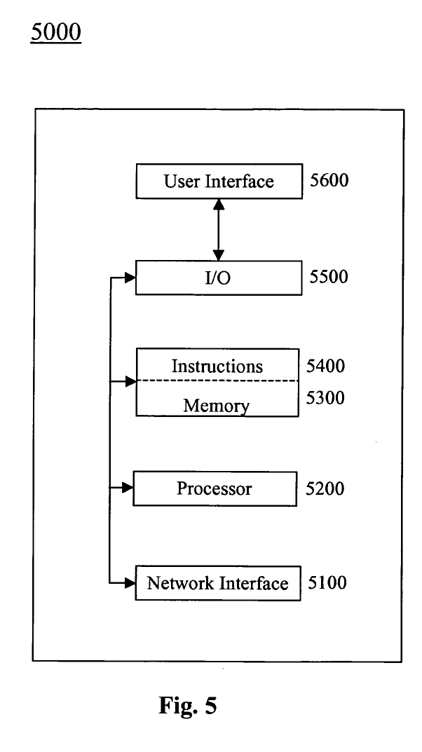

FIG. 5 is a block diagram of an exemplary embodiment of an information device 5000, which in certain operative embodiments can comprise, for example, system 1000 of FIG. 1. Information device 5000 can comprise any of numerous components, such as for example, one or more network interfaces 5100, one or more processors 5200, one or more memories 5300 containing instructions 5400, one or more input/output (I/O) devices 5500, and/or one or more user interfaces 5600 coupled to I/O device 5500, etc.

In certain exemplary embodiments, via one or more user interfaces 5600, such as a graphical user interface, a user can view a rendering of information related to researching, designing, modeling, creating, developing, building, manufacturing, operating, maintaining, storing, marketing, selling, delivering, selecting, specifying, requesting, ordering, receiving, returning, rating, and/or recommending any of the products, services, methods, and/or information described herein.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
access—(n) a permission, liberty, right, mechanism, or ability to enter, approach, communicate with and/or through, make use of, and/or pass to and/or from a place, thing, and/or person; (v) to enter, approach, communicate with and/or through, make use of, and/or pass to and/or from.
activity—an action, act, deed, function, step, and/or process and/or a portion thereof.
adapted to—suitable, fit, and/or capable of performing a specified function.
and/or—either in conjunction with or in alternative to.
apparatus—an appliance and/or device for a particular purpose.
automatically—acting and/or operating in a manner essentially independent of external human influence and/or control. For example, an automatic light switch can turn on upon “seeing” a person in its view, without the person manually operating the light switch.
based upon—determined in consideration of and/or derived from.
binarize—to convert image information to a binary form that has only two values that are based on intensity information in the original image.
binary morphology—an operation adapted to analyze image shapes in which, for each pixel in a binarized image, a selected pixel and adjacent pixels are inspected, after which the selected pixel is replaced with a pixel determined by a function that is based upon the selected pixel and the adjacent pixels. For example, binary morphology can comprise dilation, erosion, and/or various combinations thereof.
border value—a pixel value at an edge of an image and/or a portion of the image.
break detection—an algorithm adapted to analyze a topology of two-dimensional objects (blobs) in a binarized image and locate any cavity that might be present in the topology. The algorithm can utilize operations such as dilation, erosion, and/or various combinations thereof.
can—is capable of, in at least some embodiments.
cause—to bring about, provoke, precipitate, produce, elicit, be the reason for, result in, and/or effect.
circuit—an electrically conductive pathway and/or a communications connection established across two or more switching devices comprised by a network and between corresponding end systems connected to, but not comprised by the network.
City block Sobel image—an image generated based upon values obtained via a Sobel filter.
color—(n.) a visual property dependent on the reflection or absorption of light from a given surface that has characteristics of hue, intensity, and value; (v.) to change a visual property dependent on the reflection or absorption of light from a given surface that has characteristics of hue, intensity, and value.
comprise—to include, but not be limited to, what follows.
configure to design, arrange, set up, shape, and/or make suitable and/or fit for a specific purpose.
control—(n) a mechanical or electronic device used to operate a machine within predetermined limits; (v) to exercise authoritative and/or dominating influence over, cause to act in a predetermined manner, direct, adjust to a requirement, and/or regulate.
controller—a device and/or set of machine-readable instructions for performing one or more predetermined and/or user-defined tasks. A controller can comprise any one or a combination of hardware, firmware, and/or software. A controller can utilize mechanical, pneumatic, hydraulic, electrical, magnetic, optical, informational, chemical, and/or biological principles, signals, and/or inputs to perform the task(s). In certain embodiments, a controller can act upon information by manipulating, analyzing, modifying, converting, transmitting the information for use by an executable procedure and/or an information device, and/or routing the information to an output device. A controller can be a central processing unit, a local controller, a remote controller, parallel controllers, and/or distributed controllers, etc. The controller can be a general-purpose microcontroller, such the Pentium IV series of microprocessor manufactured by the Intel Corporation of Santa Clara, Calif., and/or the HC08 series from Motorola of Schaumburg, Ill. In another embodiment, the controller can be an Application Specific Integrated Circuit (ASIC) or a Field Programmable Gate Array (FPGA) that has been designed to implement in its hardware and/or firmware at least a part of an embodiment disclosed herein.
corresponding—related, associated, accompanying, similar in purpose and/or position, conforming in every respect, and/or equivalent and/or agreeing in amount, quantity, magnitude, quality, and/or degree.
count—(n.) a number reached by counting and/or a defined quantity. (v.) to increment, typically by one and beginning at zero.
create—to make, form, produce, generate, bring into being, and/or cause to exist.
data—information represented in a form suitable for processing by an information device.
define—to establish the meaning, relationship, outline, form, and/or structure of, and/or to precisely and/or distinctly describe and/or specify.
determine—to obtain, calculate, decide, deduce, establish, and/or ascertain.
device—a machine, manufacture, and/or collection thereof.
digital—non-analog; discrete.
digital camera—a camera that captures an image not on film, but in an electronic imaging sensor that takes the place of film.
Direct Memory Access (DMA)—an integrated circuit architecture
Direct Memory Access (DMA) channel—a communications bus adapted for hardware devices (e.g., sound cards, keyboards, and/or FPGA devices, etc.) to read contents from and/or write contents to a main memory of an information device without the contents of the main memory being transmitted through a primary processor of the information device.
exceeds—to be greater than.
field programmable gate array device—a semiconductor device containing programmable logic components called “logic blocks”, and programmable interconnects. Logic blocks can be programmed to perform the function of basic logic gates such as AND, and XOR, or more complex combinational functions such as decoders or mathematical functions.
first—an initial element in an ordered sequence.
from—used to indicate a source.
generate—to create, produce, render, give rise to, and/or bring into existence.
grayscale value—one or more characters that quantify an intensity of a portion of an image along a scale that varies from black at a weakest intensity to white at a strongest intensity.
grayscale image—an image comprising pixels that range in shade from black at a weakest intensity of the image to white at a strongest intensity.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
heat—energy associated with the motion of atoms and/or molecules and capable of being transmitted through solid and fluid media by conduction, through fluid media by convection, and through a fluid and/or empty space by radiation.
height—a measurement of distance between a specified point and a corresponding plane of reference.
image—an at least two-dimensional representation of an entity and/or phenomenon.
information—facts, terms, concepts, phrases, expressions, commands, numbers, characters, and/or symbols, etc., that are related to a subject. Sometimes used synonymously with data, and sometimes used to describe organized, transformed, and/or processed data. It is generally possible to automate certain activities involving the management, organization, storage, transformation, communication, and/or presentation of information.
information device—any device on which resides a finite state machine capable of implementing at least a portion of a method, structure, and/or or graphical user interface described herein. An information device can comprise well-known communicatively coupled components, such as one or more network interfaces, one or more processors, one or more memories containing instructions, one or more input/output (I/O) devices, and/or one or more user interfaces (e.g., coupled to an I/O device) via which information can be rendered to implement one or more functions described herein. For example, an information device can be any general purpose and/or special purpose computer, such as a personal computer, video game system (e.g., PlayStation, Nintendo Gameboy, X-Box, etc.), workstation, server, minicomputer, mainframe, supercomputer, computer terminal, laptop, wearable computer, and/or Personal Digital Assistant (PDA), iPod, mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, a digital signal processor, an ASIC or other integrated circuit, a hardware electronic logic circuit such as a discrete element circuit, and/or a programmable logic device such as a PLD, PLA, FPGA, or PAL, or the like, etc.
machine instructions—directions adapted to cause a machine, such as an information device, to perform one or more particular activities, operations, and/or functions. The directions, which can sometimes form an entity called a “processor”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine, such as an information device, computer, microprocessor, and/or controller, etc., can obtain and/or store data, information, and/or instructions. Examples include memories, punch cards, and/or optically-readable forms, etc.
main memory—the memory of the information device can be any device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory can be coupled to a processor and can store instructions adapted to be executed by processor according to an embodiment disclosed herein.
maximum neighborhood value—a quantity determined to be largest of a set of quantities in a predetermined region of an image.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
minimum neighborhood value—a quantity determined to be smallest of a set of quantities in a predetermined region of an image.
modify—to change, cause to change, edit, alter, replace, delete, and/or correct.
network—a communicatively coupled plurality of nodes, communication devices, and/or information devices. Via a network, such devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, multi-domain, and/or multi-zone sub-network and/or protocol, one or more Internet service providers, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, Ethernet card, cable modem, digital subscriber line interface, bridge, hub, router, or other similar device, software to manage such a device, and/or software to provide a function of such a device.
obtain—to receive, get, take possession of, procure, acquire, calculate, determine, and/or compute.
output—(n) something produced and/or generated; data produced by an information device executing machine-readable instructions; and/or the energy, power, work, signal, and/or information produced by a system. (v) to provide, produce, manufacture, and/or generate.
packet—a generic term for a bundle of data organized in a specific way for transmission, such as within and/or across a network, such as a digital packet-switching network, and comprising the data to be transmitted and certain control information, such as a destination address.
perform—to begin, take action, do, fulfill, accomplish, carry out, and/or complete, such as in accordance with one or more criterion.
perform—to begin, take action, do, fulfill, accomplish, carry out, and/or complete, such as in accordance with one or more criterion.
Peripheral Connect Interface (PCI)—a computer bus adapted for attaching peripheral devices to a computer motherboard.
pixel—a discrete element that, along with other discrete elements, forms an image.
pixel buffer—a memory adapted for temporary storage of pixel information.
plurality—the state of being plural and/or more than one.
portion—a part, component, section, percentage, ratio, and/or quantity that is less than a larger whole. Can be visually, physically, and/or virtually distinguishable and/or non-distinguishable.
predetermine—to determine, decide, or establish in advance.
predetermined threshold—a limit established in advance.
process—(n.) an organized series of actions, changes, and/or functions adapted to bring about a result; (v.) to perform mathematical and/or logical operations according to programmed instructions in order to obtain desired information and/or to perform actions, changes, and/or functions adapted to bring about a result.
processor—a hardware, firmware, and/or software machine and/or virtual machine comprising a set of machine-readable instructions adaptable to perform a specific task. A processor can utilize mechanical, pneumatic, hydraulic, electrical, magnetic, optical, informational, chemical, and/or biological principles, mechanisms, signals, and/or inputs to perform the task(s). In certain embodiments, a processor can act upon information by manipulating, analyzing, modifying, and/or converting it, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
provide—to furnish, supply, give, convey, send, and/or make available.
read—to obtain from a memory device.
receive—to gather, take, acquire, obtain, accept, get, and/or have bestowed upon.
rectangular—defined by four substantially right angles.
region—a continuous part of a surface.
render—to display, annunciate, speak, print, and/or otherwise make perceptible to a human, for example as data, commands, text, graphics, audio, video, animation, and/or hyperlinks, etc., such as via any visual, audio, and/or haptic mechanism, such as via a display, monitor, printer, electric paper, ocular implant, cochlear implant, speaker, etc.
repeatedly—again and again; repetitively.
replace—to substitute one thing for another.
request—(v.) to express a need and/or desire for; to inquire and/or ask for. (n.) that which communicates an expression of desire and/or that which is asked for.
result—an outcome and/or consequence of a particular action, operation, and/or course.
results buffer—a memory adapted for temporary storage of processed pixel information.
said—when used in a system or device claim, an article indicating a subsequent claim term that has been previously introduced.
second—an element that immediately follows an initial element in an ordered sequence.
select—to make and/or indicate a choice and/or selection from among alternatives.
set—a related plurality of predetermined elements; and/or one or more distinct items and/or entities having a specific common property or properties.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
Sobel filter—an algorithm that comprises convolving image pixels with two kernels (each of the two kernels being a matrix that comprises predetermined constant values); one kernel can be designated as GradX and the other GradY. The operation returns scalar intensity gradient information in X and Y directions for each pixel. To obtain the absolute value of an intensity gradient at a given pixel a vector summing operation is performed: Intensity gradient=SQRT(GradX̂2+GradŶ2). The intensity gradient can be roughly approximated (e.g., to within approximately 0 to approximately 45 percent) by a sum of absolute values:

Intensity gradient≈(|GradX|+|GradY|).
Sobel image—an image comprising pixels that have been operated on by a Sobel filter.
Sobel value—a numerical value of a pixel in a Sobel image.
specify—to describe, characterize, indicate, and/or state explicitly and/or in detail.
store—to place, hold, retain, enter, and/or copy into and/or onto a machine-readable medium.
substantially—to a considerable, large, and/or great, but not necessarily whole and/or entire, extent and/or degree.
sum—(n) a total obtained via addition of two or more values; (v) to add.
system—a collection of mechanisms, devices, machines, articles of manufacture, processes, data, and/or instructions, the collection designed to perform one or more specific functions.
target register read operation—a process adapted to obtain information from a predetermined memory device.
transfer—(n) a transmission from one device, place, and/or state to another. (v) to convey from one device, place, and/or state to another.
transmit—to provide, furnish, supply, send as a signal, and/or to convey (e.g., force, energy, and/or information) from one place and/or thing to another.
user interface—a device and/or software program for rendering information to a user and/or requesting information from the user. A user interface can include at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
value—a measured, assigned, determined, and/or calculated quantity or quality for a variable and/or parameter.
via—by way of and/or utilizing.
wherein—in regard to which; and; and/or in addition to.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive.

What is claimed is:

1. A method comprising:
automatically rendering an image, said image transferred to a memory from a digital camera via a Field Programmable Gate Array (FPGA) device, said FPGA device adapted to transfer image information from said digital camera to a main memory of a processor via a first direct memory access (DMA) channel, said FPGA device adapted to receive a set of image pixels from said processor via a second DMA channel, said set of image pixels corresponding to a rectangular region of said image, said FPGA device adapted to process said set of image pixels, said FPGA device adapted to transfer said set of image pixels to said processor via said second DMA channel.

2. The method of claim 1, further comprising:
processing said set of image pixels at said FPGA device.

3. The method of claim 1, further comprising:
performing a binary morphology on said set of image pixels at said FPGA device.

4. The method of claim 1, further comprising:
transferring said image information to said processor via a pixel buffer of said FPGA device.

5. The method of claim 1, further comprising:
transferring said set of image pixels to said processor via a results buffer of said FPGA device.

6. The method of claim 1, further comprising:
reading said set of image pixels from a results buffer of said FPGA device via a Peripheral Connect Interface (PCI) target register read operation.

7. The method of claim 1, further comprising:
performing a Sobel Filter operation on said set of image pixels at said FPGA device.

8. The method of claim 1, wherein:
said set of image pixels is a portion of a grayscale image determined from said image and said FPGA device is adapted to process said portion of said grayscale image and output a City block Sobel image.

9. The method of claim 1, wherein:
said set of image pixels is a portion of a grayscale image determined from said image and said FPGA device is adapted to process said portion of said grayscale image and output a binarized grayscale image.

10. The method of claim 1, wherein:
said set of image pixels is a portion of a grayscale image determined from said image and said FPGA device is adapted to process said portion of said grayscale image and output a binarized Sobel image.

11. The method of claim 1, wherein:
said set of image pixels is a portion of a grayscale image determined from said image and said FPGA device is adapted to process said portion of said grayscale image and output a sum of Sobel values for pixels of said set of image pixels with a grayscale value that exceeds a predetermined threshold.

12. The method of claim 1, wherein:
said set of image pixels is a portion of a grayscale image determined from said image and said FPGA device is adapted to process said portion of said grayscale image and output a count of Sobel values for pixels of said set of image pixels with a grayscale value that exceeds a predetermined threshold.

13. The method of claim 1, wherein:
said set of image pixels is a binarized image and said FPGA device is adapted to modify said binarized image based upon a specified border value and a height of said rectangular region of said image.

14. The method of claim 1, wherein:
said set of image pixels is a binarized image and said FPGA device is adapted to perform break detection via colored pixels of said binarized image.

15. The method of claim 1, wherein:
said set of image pixels is a grayscale image and said FPGA device is adapted to process said grayscale image and output image data that comprises a central pixel replaced by a minimum neighborhood value.

16. The method of claim 1, wherein:
said set of image pixels is a grayscale image and said FPGA device is adapted to process said grayscale image and output image data that comprises a central pixel replaced by a maximum neighborhood value.

17. A machine-readable medium comprising machine instructions for activities comprising:
automatically rendering an image, said image transferred to a memory from a digital camera via a Field Programmable Gate Array (FPGA) device, said FPGA device adapted to transfer image information from said digital camera to a main memory of a processor via a first direct memory access (DMA) channel, said FPGA device adapted to receive a set of image pixels from said processor via a second DMA channel, said set of image pixels corresponding to a rectangular region of said image, said FPGA device adapted to process said set of image pixels, said FPGA device adapted to transfer said set of image pixels to said processor via said second DMA channel.

18. A system comprising:
a digital camera adapted to obtain an image;
a processor; and
a Field Programmable Gate Array (FPGA) device, said FPGA device adapted to transfer image information from said digital camera to a main memory of a processor via a first direct memory access (DMA) channel, said FPGA device adapted to receive a set of image pixels from said processor via a second DMA channel, said set of image pixels corresponding to a rectangular region of said image information, said FPGA device adapted to process said set of image pixels, said FPGA device adapted to transfer said set of image pixels to said processor via said second DMA channel.
